(19) United States
(12) Patent Application Publication
(10) Pub. No.: US 2011/0109235 A1
(43) Pub. Date: May 12, 2011

(54) Expandable and controllable LED lighting strip

(76) Inventor: Uu Link, Changhua County (TW)

(21) Appl. No.: 12/926,240

(22) Filed: Nov. 4, 2010

(30) Foreign Application Priority Data
Nov. 10, 2009 (TW) 098220787

(51) Int. Cl. H05B 37/02

(52) U.S. Cl. 315/191

(57) ABSTRACT

An expandable and controllable LED lighting strip is in the form of a transparent long strip having a plurality of LEDs, and includes a flexible printed circuit board with the LEDs spaced thereon by a predetermined distance. The circuit board is coated with a transparent waterproof protective layer and has a male and a female connector provided to two ends thereof, allowing two or more pieces of the LED lighting strips to serially connect end to end. A control chip is packaged on a reverse side of the circuit board for controlling the LEDs on the same circuit board to operate. The LED light strips can be wound into rolls for storage, and can be serially or parallelly connected to one another to form an LED matrix for widely applying to LED signboards, indicating illuminators, lighting curtains and other furniture to provide illumination or create special atmosphere.

### FIELD OF THE INVENTION

The present invention relates to an expandable and controllable LED lighting strip, and more particularly to controllable LED lighting strips that can be flexibly wound into rolls for storage, and can be serially or parallelly connected to form an LED matrix for widely applying to various kinds of lighting products to create special atmosphere.

### BACKGROUND OF THE INVENTION

As it is known, light-emitting diodes (LEDs) has the advantages of high lighting efficiency, fast response time, long service life, damage-resistance, low power consumption, free of mercury and being environment-friendly, compactness, applicable to low-temperature environment, directional light source, and low light pollution. Therefore, LEDs have gradually replaced conventional indoor lamp bulbs. Currently, most of the LED products are applied to indicating devices, such as signboards, traffic lights, and indicating screens that are expensive and usually designed for commercial purpose. The annual market demands for LED lamps are surprisingly high, which attracts relevant industrial fields to positively invest in the research and development of different LED products.

While there are already many patents granted to different LED device inventions, the currently available structural design and control circuits in connection with LEDs are still restricted by limited techniques. Most of the conventional LED light strings have fixedly configuration. The LED light strings are rigid and could not be conveniently folded or collapsed for storage. The completed LED light strings have fixed size or length without the possibility of being freely combined to extend the length thereof or to form different LED arrays. And, unless a specific control circuit is provided, the LEDs are not freely controllable to turn on or off in desired sequence to show different still patterns or dynamic images or animations. That is, the conventional LED lighting products have poor generality and could not be freely combined in different manners to be widely applied to various kinds of products, such as LED signboards, indicating illuminators, lighting curtains, furniture, etc. Moreover, the LEDs on the conventional LED lighting products are not individually controllable to provide particular illumination or to create specific atmosphere.

It is therefore tried by the inventor to develop an improved expandable and controllable LED lighting strip to eliminate the drawbacks in the prior art LED lighting devices or products.

### SUMMARY OF THE INVENTION

A primary object of the present invention is to provide an expandable and controllable LED light strip, which is a transparent long strip having a plurality of LEDs mounted thereon, and includes a flexible printed circuit board with the LEDs spaced thereon by a predetermined distance. The circuit board is coated with a transparent waterproof protective layer and has a male and a female connector separately provided to two ends of the circuit board, allowing two or more pieces of the LED lighting strips to serially connect end to end. A control chip is packaged on a reverse side of the circuit board for controlling the LEDs on the same circuit board to operate. The LED lighting strip can be wound into a roll for storage, and can be serially or parallelly connected with other LED lighting strips to form an LED matrix.

The LED light strip with these arrangements provides good generality for widely applying to LED signboards, indicating illuminators, lighting curtains and other furniture to provide illumination or create special atmosphere.

### BRIEF DESCRIPTION OF THE DRAWINGS

The structure and the technical means adopted by the present invention to achieve the above and other objects can be best understood by referring to the following detailed description of the preferred embodiments and the accompanying drawings, wherein

FIG. 1 shows the structure of an expandable and controllable LED lighting strip according to a preferred embodiment of the present invention;

FIG. 2 shows two or more expandable and controllable LED lighting strips of the present invention can be serially connected end to end to obtain an extended overall length;

FIG. 3 is an enlarged view showing the joint between two serially connected LED lighting strips of the present invention; and

FIG. 4 shows the use of a plurality of the expandable and controllable LED lighting strips of the present invention to form a lighting curtain.

### DETAILED DESCRIPTION OF THE PREFERRED EMBODIMENTS

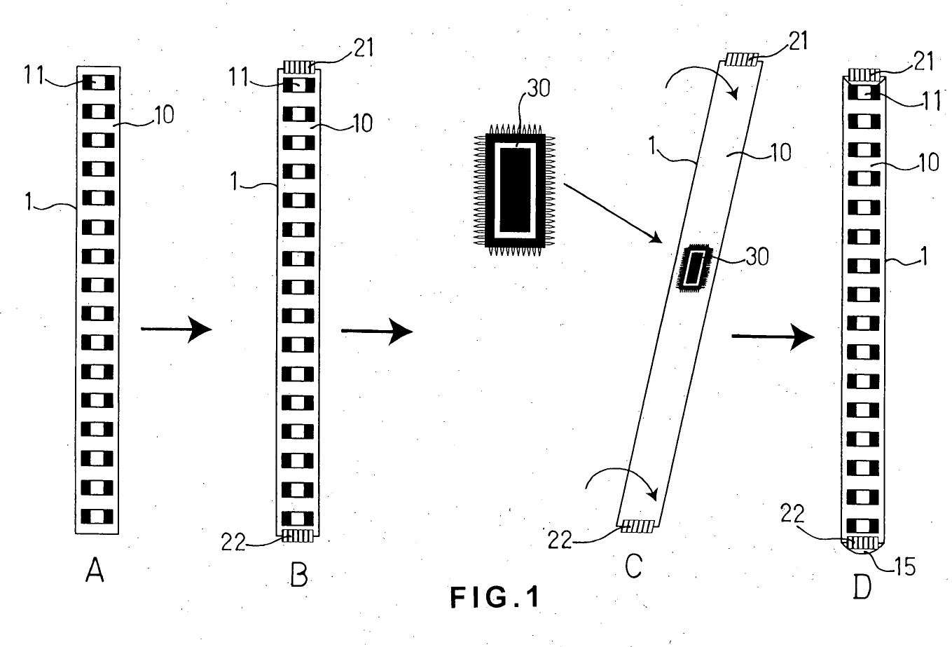

Please refer to FIGS. 1 to 4. An expandable and controllable light-emitting-diode (LED) lighting strip 1 according to a preferred embodiment of the present invention is a transparent long strip having a plurality of LEDs 11 mounted thereon.

The expandable and controllable LED lighting strip 1 includes a circuit board 10, on which the LEDs 11 are sequentially spaced at a predetermined distance. The circuit board 10 is coated with a transparent waterproof protective layer 15 formed of a suitable plastic material, for example. In practice, the circuit board 10 can be a rigid or a flexible member. Preferable, the circuit board 10 is a flexible printed circuit board 10.

A male connector 21 and a female connector 22 are separately provided on two opposite ends of the circuit board 10, so that two or more pieces of the circuit boards 10 can be serially connected end to end.

A control chip 30 is packaged on a reverse side of the circuit board 10 for controlling any desired ones of the LEDs 11 on the same one expandable and controllable LED lighting strip 1 to turn on or off.

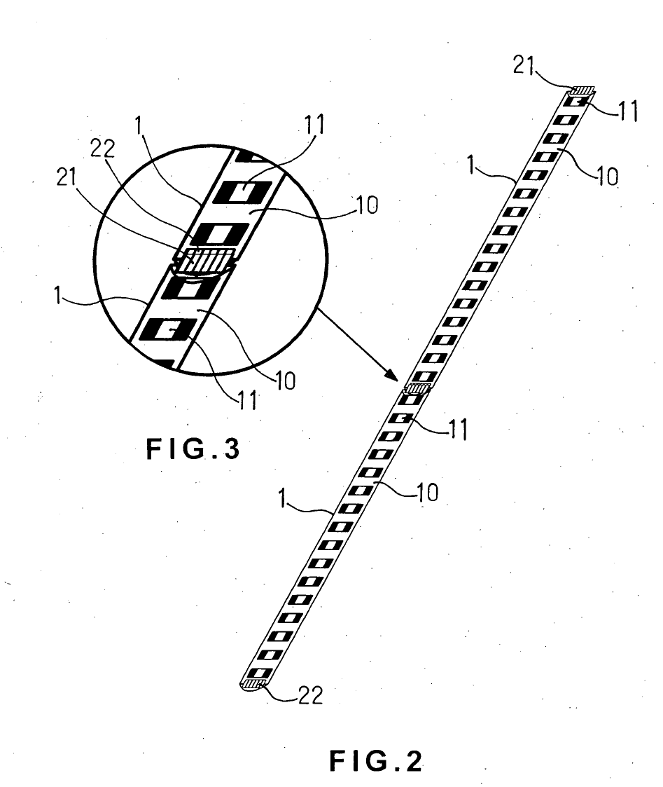

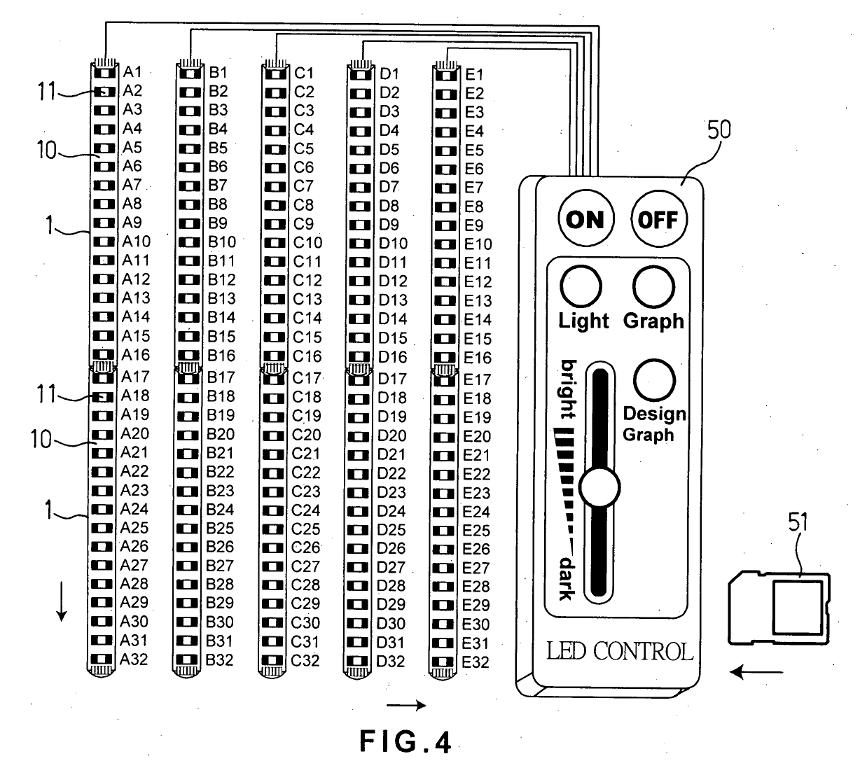

With these arrangements, the fully assembled LED lighting strip 1 not in use can be flexibly wound into a roll for convenient storage. And, when a longer LED lighting strip 1 is desired, a user can simply serially connect two or more pieces of the LED lighting strips 1 end to end via the male and female connectors 21, 22 provided on two ends of the circuit board 10, as shown in FIGS. 2 and 3. Or, a plurality of the expandable and controllable LED lighting strips 1 can be arrayed into an LED matrix, as shown in FIG. 4. Therefore, the expandable and controllable LED lighting strip 1 of the present invention has good generality for widely applying to various kinds of products, such as LED signboards, indicating illuminators, lighting curtains, furniture, etc., and can be controlled to emit light in different manners for different applications or creating unique atmosphere.

Please refer to FIG. 4. For example, a plural piece of the expandable and controllable LED light strips 1 can be used to form a lighting curtain. To do so, the expandable and controllable LED lighting strips 1 are serially connected in pairs, for example, via the male and the female connector 21, 22; and the extended LED lighting strips 1 are then parallelly arrayed to form an LED matrix with upper ends of the extended LED lighting strips 1 connected to a rail via hooks (both the rail and the hooks are not shown). Then, an LED control 50 is electrically connected to each of the extended LED lighting strips 1 to form a lighting curtain device, which can be mounted to a window in a residential house or a business office for use.

A memory card having different coded programs stored therein can be inserted into the LED control 50. A user can design personal favorite lighting patterns for the lighting curtain and saves coded programs containing the user-designed patterns in the memory card. When the LED control 50 is switched to ON and different function buttons on the LED control 50 are pushed or set to transmit different signals, the extended LED lighting strips 1 arrayed into the LED matrix can be sequentially controlled, so that the LEDs 11 on each of the LED lighting strips 1 are differently controlled by the signals transmitted from the LED control 50 to display characters, designs or animations, or to show different brightness levels on the LED lighting strips 1. Thus, the LED lighting strips 1 can be used as a display screen for showing patterns or animations or as a still lighting fixture. That is, the LED lighting strips 1 of the present invention can be combined, arrayed and controlled in a manner completely different from and superior to the conventional LED array controlling modes, and can therefore be widely applied in various domestic appliances.

Due to the unique structural design thereof, the LED lighting strips 1 of the present invention can be employed not only in various kinds of products in connection with LED signboards, indicating illuminators, furniture, etc., but also in room illumination. Moreover, the brightness of the LED lighting strips 1 can be conveniently regulated via the LED control 50, and the LEDs 11 can replace general home lighting fixture to save about 89% of power consumption, compared to conventional lamps with the same brightness.

As described above, a plural piece of the LED light strips 1 can be arrayed to form a unique lighting curtain, which provides multiple functions, including illuminating, creating special atmospheres, indicating messages, shielding sight, screening sunlight, etc. For example, by operating the LED control 50 to control the on/off and the brightness of the LEDs 11 on each of the LED lighting strips 1, different patterns, animations, and other indicating symbols can be shown on the lighting curtain, or different atmospheres can be created for a room. For instance, a scene of a snowing night or a Santa Claus streaking across the window can be shown on the lighting curtain on Christmas Eve; a birthday card can be shown on the lighting curtain in a house on a family member's birthday; or some messages, such as a special discount offered, can be displayed on the lighting curtain in a show window of a shop without the need of installing additional signboards or other externally mounted LED lamps.

The present invention has been described with a preferred embodiment thereof and it is understood that many changes and modifications in the described embodiment can be carried out without departing from the scope and the spirit of the invention that is intended to be limited only by the appended claims.

What is claimed is:

1. An expandable and controllable LED lighting strip being a transparent long strip having a plurality of LEDs mounted thereon, comprising:
a circuit board, on which the LEDs are spaced at a predetermined distance; and
the circuit board being coated with a transparent waterproof protective layer;
a male and a female connector being separately provided on two opposite ends of the circuit board, so that two or more pieces of the circuit boards can be serially connected end to end; and
a control chip being packaged on the circuit board for controlling any desired ones of the LEDs mounted on the same circuit board to turn on or off;
whereby two or more pieces of the fully assembled LED lighting strips can be serially connected to have an extended length and can be parallelly arrayed to form an LED matrix for using in various kinds of lighting applications to illuminate a space or create a desired atmosphere.

2. The expandable and controllable LED lighting strip as claimed in claim 1, wherein the circuit board is a flexible printed circuit board.

3. The expandable and controllable LED lighting strip as claimed in claim 1, wherein the control chip is packaged on a reverse side of the circuit board.

4. The expandable and controllable LED lighting strip as claimed in claim 1, further comprising an LED control; and wherein the plural pieces of parallelly arrayed LED lighting strips forming the LED matrix are connected at respective upper ends to a rail via a hook each to thereby form a lighting curtain, and the LEDs on the lighting curtain are differently controllable by operating on the LED control.

5. The expandable and controllable LED lighting strip as claimed in claim 4, wherein the LED control allows a memory card having coded programs stored therein to insert into the LED control for controlling the lighting curtain to display still patterns or dynamic images or animations thereon according to a user's preference.
